(19) United States
(12) Patent Application Publication
(10) Pub. No.: US 2003/0230537 A1
(43) Pub. Date: Dec. 18, 2003

(54) Method and system for water purification

(75) Inventors: Hiroshi Taoda, Aichi (JP); Masanori Sakakibara, Aichi (JP); Tamotsu Katoh, Aichi (JP); Akito Asaoka, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Natl. Inst. of Adv. Indust. Sci. & Tech., Tokyo (JP)

(21) Appl. No.: 10/353,037

(22) Filed: Jan. 29, 2003

(30) Foreign Application Priority Data
Jun. 17, 2002 (JP) 2002-175199

(51) Int. Cl. C02F 1/48

(52) U.S. Cl. 210/695; 210/747; 210/702; 210/201; 210/223

(57) ABSTRACT

The present invention provides a method for water purification characterized in that a catalyst supporting iron and titanium oxide is mixed into the water to be treated containing suspended matter, and the suspended matter is adsorbed, decomposed, and precipitated, and the above-mentioned method for water purification is also characterized in that a catalyst supporting iron and titanium oxide and supported on a carrier is brought into contact with the wastewater or other water to be treated containing suspended matter, and the suspended matter is adsorbed, decomposed, and precipitated and further provides a water purifying agent produced by compounding an iron component with titanium oxide, and containing as an active component a catalyst supporting iron and titanium oxide, and a system thereof.

### BACKGROUND OF THE INVENTION

1. Field of the Invention

The present invention relates to a method and system for water purification that make use of a catalyst supporting iron and titanium oxide, and more particularly relates to a novel method for water purification in which an iron component is compounded with a titanium oxide-based photocatalyst to obtain a catalyst supporting iron and titanium oxide, and the organic suspended matter, agrochemicals, endocrine disruptors, and other such impurities contained in water to be treated containing suspended matter, such as tap water, sewage, municipal runoff, agricultural runoff, industrial wastewater, lake or marsh water, or river water, is adsorbed, decomposed, and precipitated using this catalyst, which makes it possible to purify water to be treated in a short time and at high speed, and further relates to a water purifying agent containing the above-mentioned catalyst supporting iron and titanium oxide as an active component, and to a system for water purification thereof.

2. Description of the Related Art

As water pollution caused by industrial wastewater or activated wastewater has worsened in recent years, the resulting eutrophication of lakes, marshes, and rivers has become a major cause of the large amounts of algae, plankton, and so forth being generated. This has led to more facilities for handling city water and sewage, facilities for handling agricultural and municipal runoff, and so forth. In view of this, standard methods that have been employed to treat wastewater have included physical treatment involving screening and precipitation, biochemical consumption and metabolism of organic matter using microbes, biological treatment involving oxidation decomposition, and chemical treatment such as agglomeration or sterilization.

Thus, physical treatments, biological treatments, and chemical treatments are currently being used for water purification, and the adsorption and removal of organic matter with activated carbon, and sterilization with hypochlorous acid or the like are performed in order to obtain cleaner water in the final treatment. Problems encountered with these methods, however, are what to do with the activated carbon after the adsorption treatment, and the generation of trihalomethane from the residual chlorine. Also, under current released water quality standards, it is difficult to reuse treated water such as agricultural water because a considerable amount of organic matter remains in the treated water even after purification, and meeting more stringent wastewater standards will require further removal of this organic matter. To this end, some water purification plants have begun including activated carbon processing equipment, but this has entailed a new problem in terms of having to recover the activated carbon that has adsorbed organic matter or the like.

A problem with chemical treatment involving chlorine sterilization is that the residual chlorine reacts with the organic matter contained in untreated water, producing trihalomethane, which is a carcinogenic substance. In city water treatment, the nonylphenol contained in neutral detergents, for example, was classified as an endocrine disrupter in December of 2001, and as for low-dose effects, it has been reported that this substance can be toxic even in trace amounts, so it is important that this compound be decomposed.

Meanwhile, facilities that treat agricultural runoff are designed to allow the reuse of treated water for agricultural purposes in order to more effectively utilize our water resources, but water can only be purified to a COD of about 20 mg/L with existing biological treatment technology, so activated carbon treatment, chemical treatment, ozone treatment, and so forth are performed to lower the COD to 10 mg/L or less and allow the water to be released into rivers. However, treated water has to be further purified to the agricultural water quality standard COD of 6 mg/L or less for it to be reused as agricultural water. Consequently, treated water cannot at the present time be reused for agricultural purposes.

Given this situation, and in light of the above prior art, the inventors conducted diligent research aimed at developing a novel method for water purification that would allow treated water to be reused as agricultural water and so forth. In the course of this research and development, they discovered that the desired object could be achieved by using an iron-containing compounded titanium oxide-based photocatalyst (hereinafter referred to as “catalyst supporting iron and titanium oxide”) produced by compounding an iron component with a titanium oxide-based photocatalyst. Further research led to the perfection of the present invention.

### SUMMARY OF THE INVENTION

Specifically, in light of the above, it is an object of the present invention to provide a novel method for water purification with which suspended organic matter, agrochemicals, endocrine disruptors, and the like contained in water and wastewater can be removed easily and quickly, and safe water can be obtained, merely by adding relatively simple equipment to an existing facility.

It is another object of the present invention to provide a novel method for water purification with which water can be purified to the agricultural water quality standard COD of 6 mg/L or less, for example, by using a catalyst supporting iron and titanium oxide to purify water to be treated containing suspended matter, either with or without optical irradiation, and to provide a novel system for water purification with which treated water purified with the above method is reused, allowing the creation of a new base technology for water purification that can play an important role in a regional recycling system.

The present invention that solves the above problems is constituted by the following technological means.

(1) A method for water purification, comprising treating water containing suspended matter to obtain purified water by using a catalyst supporting iron and titanium oxide.

(2) The method for water purification according to (1) above, wherein the catalyst supporting iron and titanium oxide is mixed into the water to be treated containing suspended matter, and thereby the suspended matter is adsorbed, decomposed, and then precipitated.

(3) The method for water purification according to (2) above, wherein the catalyst supporting iron and titanium oxide is mixed into the water to be treated containing suspended matter while oxygen is introduced into the water.

(4) The method for water purification according to (1) above, wherein a catalyst supporting iron and titanium oxide and supported on a carrier is brought into contact with the water to be treated containing suspended matter, and thereby the suspended matter is adsorbed, decomposed, and then precipitated.

(5) The method for water purification according to (4) above, wherein a catalyst supporting iron and titanium oxide and supported on a carrier is brought into contact with the water to be treated containing suspended matter while oxygen is introduced into the water.

(6) The method for water purification according to any of (1) to (5) above, wherein when the water to be treated contains a high concentration of suspended matter, the obtained treated water is purified by being put back into the water.

(7) The method for water purification according to (2) or (3) above, wherein when the water to be treated contains a high concentration of suspended matter, the catalyst supporting iron and titanium oxide is put back into the water for purification of the water.

(8) The method for water purification according to any of (1) to (7) above, wherein the used catalyst supporting iron and titanium oxide is separated and recovered from the treated water by utilizing the action of a magnet to be reused as needed.

(9) The method for water purification according to (8) above, wherein in order to separate the catalyst supporting iron and titanium oxide from the treated water, an electromagnet is used to lift the catalyst supporting iron and titanium oxide out of the treatment tank to be reused.

(10) The method for water purification according to (8) above, wherein in order to separate the catalyst supporting iron and titanium oxide from the treated water, an electromagnet is used to fix the catalyst supporting iron and titanium oxide on the bottom of the treatment tank to be reused after the treated water is drained.

(11) The method for water purification according to any of (1) to (10) above, wherein the water to be treated is tap water, sewage, municipal runoff, agricultural runoff, industrial wastewater, lake or marsh water, or river water.

(12) A method for water purification comprising the method for water purification according to any of (1) to (11) above and another water purification process involving physical treatment, chemical treatment, or biological treatment combined with the method.

(13) A water purifying agent to be used in the method for water purification according to any of (1) to (12) above, characterized by containing as an active component a catalyst supporting iron and titanium oxide that is manufactured by compounding an iron component with a titanium oxide-based photocatalyst.

(14) The water purifying agent according to (13) above, wherein the iron component is one or more types selected from among metallic iron, iron oxide, and ferrates.

(15) A system for water purification, comprising:

an agitation tank equipped with agitation means;

water to be treated introduction means;

treated water discharge means; and

optionally optical irradiation means,

wherein water to be treated containing suspended matter is introduced into the agitation tank, a catalyst supporting iron and titanium oxide is mixed into the water to purifying the water, and then the treated water is discharged from the treated water discharge means.

(16) A compound system for water purification comprising system for water purification according to (15) above as a constituent element and other water purification equipment involving physical treatment, chemical treatment, or biological treatment, combined with the system.

### BRIEF DESCRIPTION OF THE DRAWINGS

FIG. 1 illustrates an example of the system for water purification of the present invention;

FIG. 2 illustrates another example of the system for water purification of the present invention;

FIG. 3 illustrates another example of the system for water purification of the present invention;

FIG. 4 shows the effect of water purification as a function of the amount of titanium oxide added under agitation;

FIG. 5 shows the effect of water purification of titanium oxide as a function of the ultraviolet irradiation intensity;

FIG. 6 shows the effect of water purification of titanium oxide as a function of the agitation intensity;

FIG. 7 shows the effect of water purification of titanium oxide;

FIG. 8 shows the effect of water purification as a function of the amount of added catalyst supporting iron and titanium oxide;

FIG. 9 shows the effect of water purification of an iron oxide;

FIG. 10 shows the effect of water purification of a catalyst supporting iron and titanium oxide as a function of treatment time;

FIG. 11 shows the effect of water purification of a catalyst supporting iron and titanium oxide as a function of wastewater concentration; and

FIG. 12 shows the effect of water purification of a catalyst supporting iron and titanium oxide as a function of whether light is used.

### DESCRIPTION OF THE PREFERRED EMBODIMENT

The present invention will now be described in further detail.

The present invention relates to a novel method for water purification in which a catalyst supporting iron and titanium oxide is mixed into water to be treated, such as service water or wastewater containing suspended matter such as suspended organic matter, the water is irradiated with light optionally, and then agitated or exposed to the air so as to introduce oxygen into the water to be treated, while the suspended matter is adsorbed, decomposed, and precipitated. The catalyst supporting iron and titanium oxide, etc., is separated as a precipitate following the agitation or air exposure, and the supernatant is collected as the treated water, and this water purification is performed at high speed. In the present invention, the phrase “water to be treated containing suspended matter” means, for example, water to be treated that contains organic and inorganic substances, sludge, skeletal remains of microbes, and other such suspended matter that does not dissolve in the water but instead floats dispersed in the form of extremely fine particles, but is not limited to the above.

In the present invention, the catalyst supporting iron and titanium oxide is a compound catalyst in which titanium oxide and iron are exposed on the surface, and is produced by compounding an iron component with a titanium oxide-based photocatalyst. This includes, for instance, not just catalysts in which iron or an iron compound is supported on a titanium oxide carrier, but also the opposite, in which titanium oxide is supported on an iron or iron compound carrier, or a catalyst in which titanium oxide and iron or an iron compound are supported on a carrier of silica, alumina, a ceramic, cement, concrete, or the like. Examples of iron compounds include FeO, Fe₂O₃, Fe₃O₄₁ and other such oxides, and ferrates containing heavy metals such as manganese, cobalt, nickel, zinc, cadmium, copper, magnesium, barium, chromium, barium, or titanium, such as zinc ferrate, manganese ferrate, manganese-zinc ferrate, and nickel-zinc ferrate, but the iron compound is not limited to these examples, and any compound that has the same effect as these can be similarly used. Examples of titanium oxides include not only those with crystals such as anatase, rutile, or brookite, but also those having oxygen defects, and titanium oxide that has been doped with a metal, nitrogen, sulfur, or the like. Specifically, the titanium oxide is not limited in the present invention.

In the present invention, the catalyst supporting iron and titanium oxide can be favorably obtained, for example, by a method in which iron or an iron compound is mixed into titanium oxide particles and this mixture is molded, a method in which titanium oxide particles are mixed into iron or an iron compound and this mixture is molded, a method in which particles of titanium oxide and iron or an iron compound are mixed into silica, alumina, a ceramic, cement, concrete, or another such carrier and this mixture is molded, a method in which an alkoxide of iron or organoiron is hydrolyzed on the surface of titanium oxide or a carrier containing titanium oxide, and this product is then fired, or a method in which an alkoxide of titanium or organotitanium is hydrolyzed on the surface of a carrier of iron or an iron compound, and this product is then fired. The present invention is not, however, limited to these methods.

Nor are there any particular restrictions on how these components are blended or in what ratio, but favorable examples include blending titanium oxide and an iron compound in a ratio of about 1:1, 2:1, or 1:2. The particle size of the catalyst supporting iron and titanium oxide is preferably 0.1 to 100 μm, for example. In the present invention, the catalyst supporting iron and titanium oxide can be used in a variety of forms, such as particles, spheres, needles, cylinders, rugby-ball-shaped pieces, prisms, fibers, or blocks, but it is preferable to use a form with a large surface area, such as fine particles or fibers.

With the present invention, the above-mentioned catalyst supporting iron and titanium oxide is mixed into or brought into contact with the water to be treated, such as wastewater containing suspended matter, either under optical irradiation or not, and the suspended matter is adsorbed to the catalyst and precipitated while being decomposed by photocatalytic action, which purifies the water at high speed and in a short time. As will be shown in the examples that follow, with the present invention, using the above-mentioned catalyst supporting iron and titanium oxide (including one that has already been irradiated with light) yields a water purification effect regardless of whether optical irradiation is performed, and this was corroborated for the first time by the experiments conducted by the inventors. Specifically, the present invention also encompasses a method in which water to be treated is purified using a catalyst supporting iron and titanium oxide that has already been irradiated with light.

Also, the present invention employs a method in which the above-mentioned catalyst supporting iron and titanium oxide is mixed into wastewater or the like, and a method in which the above-mentioned catalyst supporting iron and titanium oxide is supported on a porous carrier, and this compound is brought into contact with the above-mentioned wastewater, etc., or any other method having the same effect as these. In this case, examples of carriers include porous carriers such as, specifically, silica, alumina, a ceramic, cement, concrete, or a clay sinter, but this list is not intended to be comprehensive, and any carrier that has the same effect as these can be used. Nor are there any particular restrictions on the form of the carrier. The present invention also provides a water purifying agent containing as an active component a catalyst supporting iron and titanium oxide produced by compounding the above-mentioned iron component with a titanium oxide-based photocatalyst. In this case, in addition to the above-mentioned active component, other components can also be added as needed. There are no particular restrictions on the form of the water purification agent.

With the present invention it is possible to purify water by putting the obtained treated water back into the wastewater or other treatment water, and particularly when the concentration of the suspended matter in the wastewater or the like is high, it is preferable to lower the concentration of the suspended matter in the wastewater or the like in this way during water purification. Also, with the present invention, when the concentration of the suspended matter in the wastewater or the like is high, it is preferable to put the above-mentioned catalyst supporting iron and titanium oxide back into the wastewater or the like and lower the concentration of the suspended matter in the wastewater or the like in steps during the water purification. Also, with the present invention, it is preferable for the above-mentioned catalyst supporting iron and titanium oxide to be mixed into or brought into contact with the wastewater or the like while oxygen is introduced into the wastewater or the like by some means such as agitation or exposure to air.

Irradiating a photocatalyst with light generates electrons and holes, which react with the oxygen and so forth dissolved in the water and generate active oxygen. This active oxygen is far more oxidative than ozone and the like, and renders organic matter harmless by oxidizing and decomposing it into water and carbon dioxide. However, as the oxygen is depleted, the photocatalyst becomes unable to produce active oxygen, until the organic matter can no longer be decomposed. Active oxygen production is improved when oxygen is introduced into the wastewater or the like. As a result, when the above-mentioned catalyst supporting iron and titanium oxide is used, its photocatalytic action promotes the adsorption, decomposition, and precipitation of the above-mentioned suspended matter, allowing the water to be treated to be purified at high speed and in a short time.

With the present invention, the catalyst supporting iron and titanium oxide is magnetic as a whole, and therefore a magnet can be utilized to separate and recover this catalyst from the treated water, allowing it to be reused as needed. To separate the catalyst supporting iron and titanium oxide from the treated water, the catalyst supporting iron and titanium oxide can be lifted from the treatment tank with an electromagnet, then dried as needed for reuse. It is also possible to separate the catalyst supporting iron and titanium oxide from the treated water, for example, by fixing the catalyst supporting iron and titanium oxide to the bottom of the treatment tank with an electromagnet, then drying the catalyst as needed for reuse after the treated water has been drained.

Next, the present invention provides a method for water purification system method, comprising an agitation tank equipped with agitation means, wastewater or other treatment water introduction means, treated water discharge means, and, optionally, optical irradiation means, wherein water to be treated containing suspended matter is introduced into the agitation tank, a catalyst supporting iron and titanium oxide is mixed into the water to be treated, a treatment for water purification is performed, and the treated water is discharged from the treated water discharge means. In this case, there are no particular restrictions on the specific constitution of the agitation means, agitation tank, wastewater or other water to be treated introduction means, treated water discharge means, or optical irradiation means, and these components can be suitably designed as dictated by the type of wastewater, etc., the treatment purpose, and other such factors. Also, as shown in the embodiments that follow, an agitation motor, a collector pipe and collector pan in which the catalyst supporting iron and titanium oxide is discharged and collected, a crane equipped with an electromagnetic terminal for taking out the catalyst supporting iron and titanium oxide, an electromagnet for fixing the compound, etc., that has precipitated at the bottom of the agitation tank to this bottom, or a light source such as an ultraviolet lamp having an optical irradiation function can be provided as needed.

In the present invention, examples of the light source used for optical irradiation include sunlight, visible light, a mercury vapor lamp, a xenon lamp, a black light, a chemical light, an LED, a halogen lamp, a metal halide lamp, an incandescent lamp, and a fluorescent lamp, but the light source is not limited to these. Also, with the present invention, the above-mentioned method for water purification can be used as needed in combination with another method for water purification involving physical treatment, chemical treatment, or biological treatment. Also, the above-mentioned system for water purification can be used in combination with other water purification equipment involving physical treatment, chemical treatment, or biological treatment, creating a composite system for water purification that includes the above-mentioned system for water purification as a constituent element. The specific constitution of these methods and systems can be designed as necessary according to the intended use.

The present invention will now be described in specific terms through reference to the drawings, but it should go without saying that the present invention is not limited to the following examples, and can be modified in its design as needed according to the intended use.

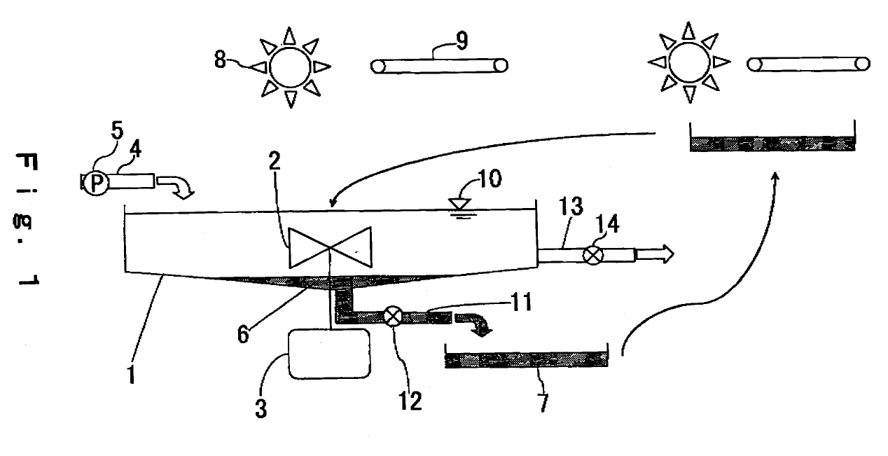

FIG. 1 illustrates an example (Embodiment 1) of the system for water purification of the present invention. This system for water purification comprises an agitation tank 1, an agitator blade 2, an agitator motor 3, a sewage inlet pipe 4, a sewage inflow pump 5, a catalyst supporting iron and titanium oxide 6, a collector pan 7, a collector pipe 11, a collection regulator valve 12, a treated water discharge pipe 13, and a treated water discharge valve 14. The operation of this system for water purification will now be described. Sewage is pumped through the sewage inlet pipe 4 into the agitation tank 1 by the sewage inflow pump 5, the agitator blade 2 is rotated by the agitator motor 3 installed underneath the agitation tank 1, the catalyst supporting iron and titanium oxide 6 is added under optical irradiation with sunlight 8 or an ultraviolet lamp 9, and the system is agitated for a specific amount of time (about 45 minutes, for example).

After this, a precipitation treatment (such as allowing the treated water to stand for 15 minutes) is performed to separate the catalyst supporting iron and titanium oxide 6, then the treated water discharge valve 14 is opened to allow the water to flow out through the treated water discharge pipe 13, and the catalyst supporting iron and titanium oxide 6 goes out of the bottom of the agitation tank 1, through the open collection regulator valve 12 and the collector pipe 11, to the collector pan 7.

In order to remove any adsorbed but undecomposed organic matter so that the catalyst supporting iron and titanium oxide 6 can be reused, the catalyst is spread out and dried in the collector pan 7 by being irradiated with ultraviolet rays from sunlight 8 or the ultraviolet lamp 9, and once the decomposition is complete (after about 3 days, for example), the catalyst is put back into the agitation tank 1 and the same operation as above is repeated. Since there will be some decrease in the photocatalytic effect when the catalyst is put back in here (a decrease of 15%, for example), additional catalyst supporting iron and titanium oxide 6 is put in to compensate for the drop in activity.

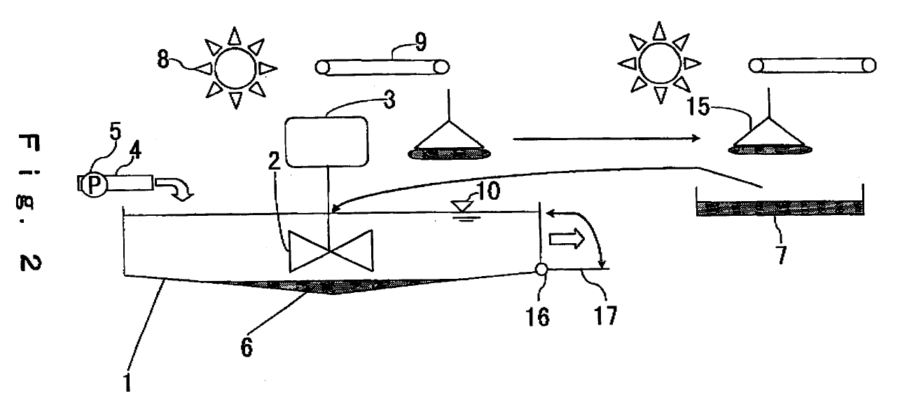

FIG. 2 illustrates another example (Embodiment 2) of the system for water purification of the present invention. This system differs from that in Embodiment 1 in that it has an electromagnetic terminal-equipped crane 15, a flip-down gate hinge 16, and a flip-down gate plate 17. Treated sewage is subjected to a precipitation treatment in order to remove the catalyst supporting iron and titanium oxide 6, after which the water is released to the outside of the agitation tank 1 by lowering the flip-down gate plate 17, the catalyst supporting iron and titanium oxide 6 is lifted out from the top of the agitation tank 1 by the electromagnetic terminal-equipped crane 15 and sent to the collector pan 7, and then the power is switched off so that the catalyst supporting iron and titanium oxide 6 falls into the collector pan 7.

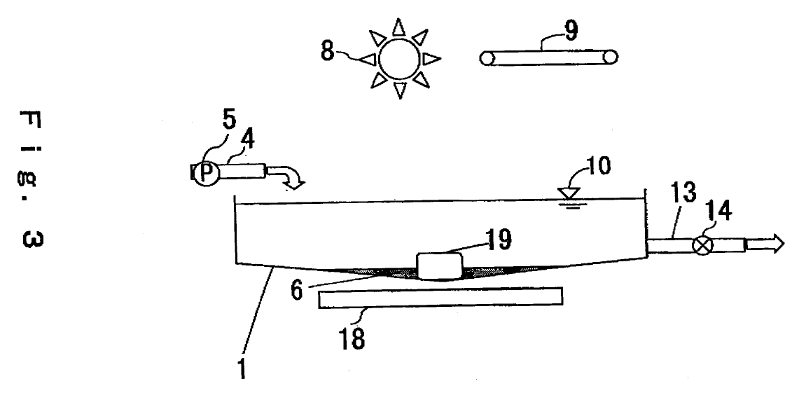

FIG. 3 illustrates another example (Embodiment 3) of the system for water purification of the present invention. This system differs from that in Embodiment 1 in that it has an electromagnet 18. Treated sewage is subjected to a precipitation treatment (such as allowing it to stand for 15 minutes) in order to remove the catalyst supporting iron and titanium oxide 6, after which the catalyst is fixed on the bottom by the electromagnet. In order to remove any adsorbed but undecomposed organic matter so that the catalyst can be reused, the catalyst is dried by being irradiated with ultraviolet rays from sunlight 8 or the ultraviolet lamp 9, and once the decomposition is complete (after about 3 days, for example), sewage is put back into the agitation tank 1, and the same operation as above is repeated. Since there will be some decrease in the photocatalytic effect when the catalyst is reused here (a decrease of 15%, for example), additional catalyst supporting iron and titanium oxide 6 is put in to compensate for the drop in activity.

The present invention is characterized in that a catalyst supporting iron and titanium oxide is mixed into or brought into contact with wastewater or other water to be treated containing suspended matter, the suspended matter is adsorbed to this catalyst, and the suspended matter is precipitated while being decomposed by the photocatalytic action of this catalyst, which affords a high-speed treatment for water purification. With the present invention, the above-mentioned adsorption, decomposition, and precipitation are all accomplished in a short time through the use of the above-mentioned catalyst supporting iron and titanium oxide, so water to be treated can be purified at high speed to the agricultural water quality standard or lower by a simple operation that merely entails taking off the supernatant after the above-mentioned precipitation.

Even with conventional methods, the organic chemical substances contained in water could be more or less decomposed to a safe level by treatment with a photocatalyst, but the decomposition took a long time with these methods when the concentration of suspended or organic matter was high, and furthermore, when a titanium oxide photocatalyst was used in the form of fine particles with a large surface area, the particles would not precipitate in the water, which made it difficult to separate the catalyst from the treated water. With the method of the present invention, however, even a large amount of suspended matter or organic matter can be easily treated, and furthermore, this matter can be adsorbed, decomposed, and precipitated at high speed and in a short time, and since the above-mentioned catalyst supporting iron and titanium oxide can be easily separated from the treated water, the present invention is useful in that it provides a novel method for water purification and system thereof with which the problems encountered with prior art can be completely eliminated.

### EXAMPLES

The present invention will now be described in specific terms through reference examples and working examples, but the present invention is not limited in any way by the following examples, etc.

### Reference Example 1

(1) Titanium Oxide

Because it was considered to have the highest activity, anatase-type ultrafine particles (with a diameter of 17 mm or less) were used as the titanium oxide.

(2) Method

The effect of water purification attributable to the photocatalytic action of titanium oxide under agitation was examined at different amounts of titanium oxide, 4 g, 6 g, 8 g, and 10 g of titanium oxide was put into four hard glass 500 mL beakers containing sewage with a COD concentration of 58 mg/L, the water was sampled 1, 2, 4, 8, and 24 hours after the start of the experiment while the samples were irradiated with ultraviolet rays (0.4 mW/cm²) from a UV lamp and while being agitated with a stirrer, and the change in the COD concentration in the sewage was examined. As a control, no titanium oxide was added and no ultraviolet irradiation was performed in a comparative example.

(3) Results

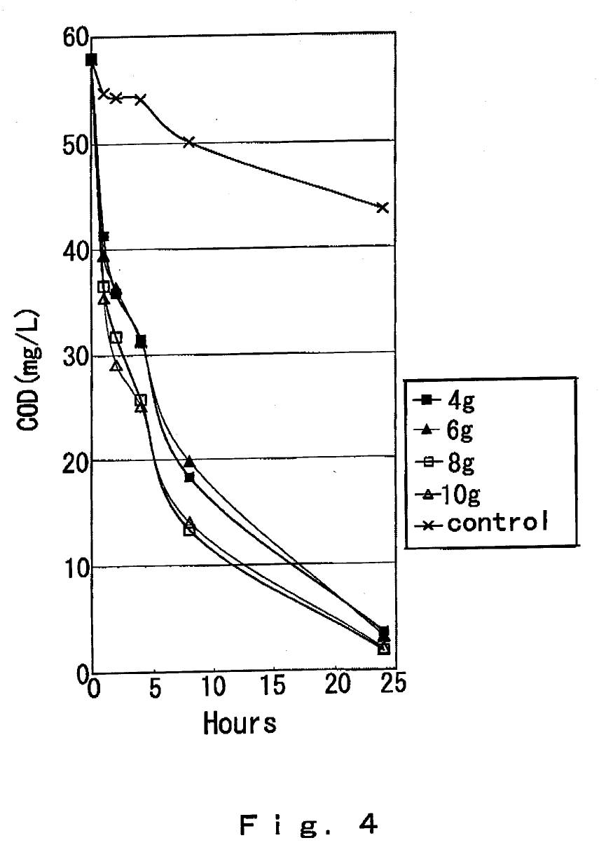

The results are given in FIG. 4. As is clear from this graph, when titanium oxide was added and the system agitated, water purification proceeded over time, with the COD in the sewage dropping to about 2 to 4 mg/L after 24 hours, which clearly demonstrates the effect of water purification due to the photocatalytic action of the titanium oxide. These results also tell us that the amount in which the titanium oxide is added per 500 mL of sewage should be about 5 g, since there is little difference in the effect of water purification between 4 and 10 g.

### Reference Example 2

(1) Method

The effect of water purification attributable to the photocatalytic action of titanium oxide was examined at different ultraviolet irradiation intensities, 10.0 g of titanium oxide was put into a hard glass 500 mL beaker containing sewage with a COD concentration of 43 mg/L, the water was sampled 1, 2, 4, 8, and 24 hours after the start of the experiment while the samples were irradiated with ultraviolet rays at intensities of 0.1, 0.2, 0.4, and 0.6 mW/cm², without any agitation, and the change in the COD concentration in the sewage was examined. As a control, no titanium oxide was added and no ultraviolet irradiation was performed in a comparative example.

(2) Results

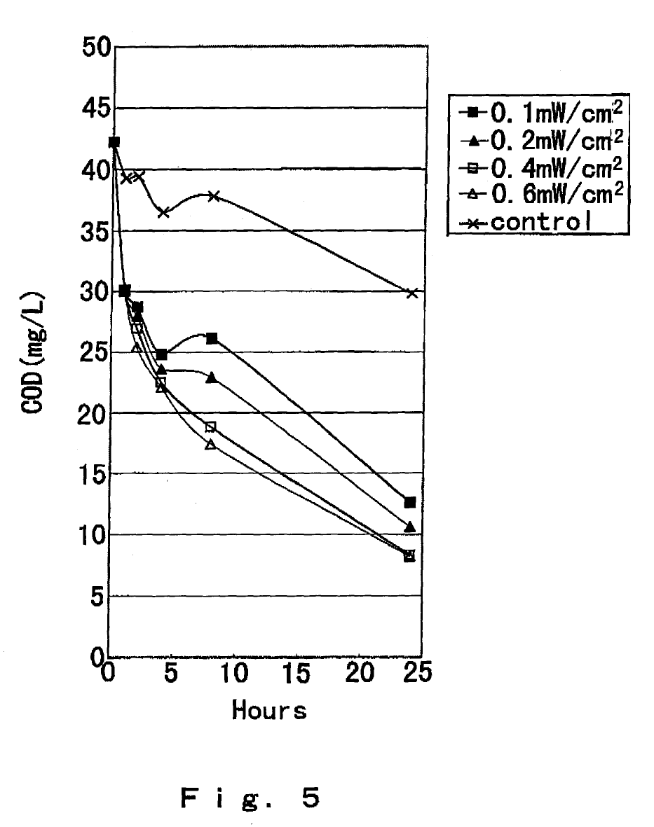

The results are given in FIG. 5. As is clear from this graph, water purification increased in proportion to the ultraviolet irradiation intensity, with the COD concentration in the sewage dropping to about 8 mg/L after 24 hours at 0.4 and 0.6 mW/cm². These results indicated that the best ultraviolet irradiation intensity was 0.4 mW/cm². The reason the COD concentration was not reduced as much in FIG. 5 as in FIG. 4 is believed to be that there was no agitation.

### Reference Example 3

(1) Method

The effect of water purification attributable to the photocatalytic action of titanium oxide was examined at different agitation intensities, 10.0 g of titanium oxide was put into a hard glass 500 mL beaker containing sewage with a COD concentration of 44 mg/L, the system was agitated at four different intensities (high, medium, low, and none) with a stirrer, the water was sampled 1, 2, 4, 8, and 24 hours after the start of the experiment while the samples were irradiated with ultraviolet rays 0.4 mW/cm²) from a UV lamp, and the change in the COD concentration in the sewage was examined. As a control, no titanium oxide was added and no ultraviolet irradiation was performed in a comparative example.

(2) Results

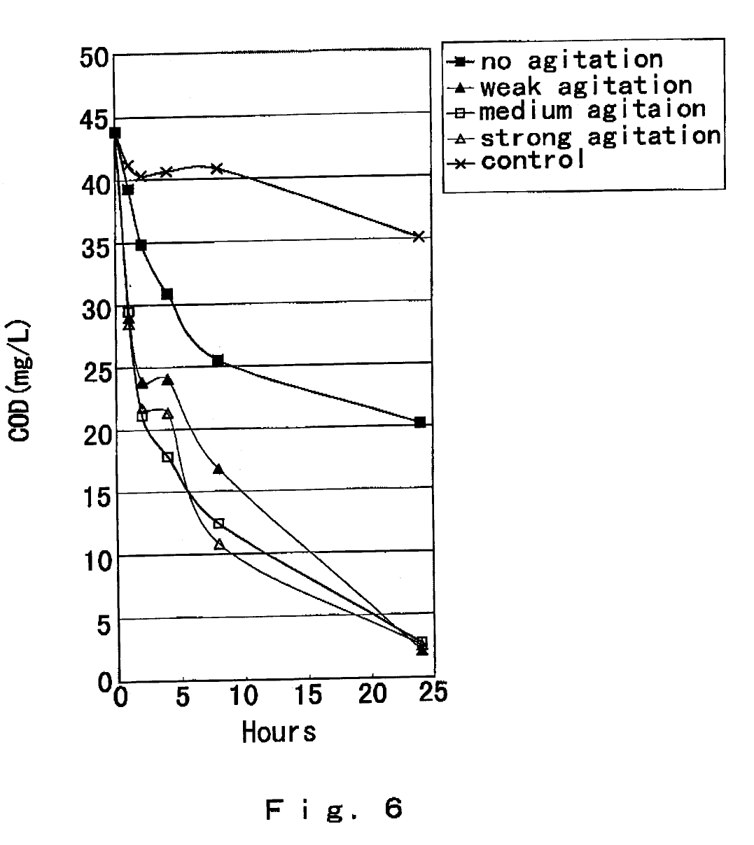

The results are given in FIG. 6. As is clear from this graph, water purification increased over time under agitation, with the COD concentration in the sewage dropping to about 2 to 3 mg/L after 24 hours. These results indicated that there was substantially no difference attributable to agitation intensity, but that water purification is improved by a certain amount of agitation.

### Reference Example 4

(1) Method

The effect of water purification attributable to the photocatalytic action of titanium oxide was examined with and without titanium oxide being added and with and without ultraviolet irradiation, 500 mL of sewage with a COD concentration of 60 mg/L was put into five hard glass beakers, and five samples were prepared: 1) 5.0 g of titanium oxide was added and the system was agitated while being irradiated with ultraviolet rays (0.4 mW/cm²) from a UV lamp, 2) 5.0 g of titanium oxide was added and the system was agitated, but was not irradiated with ultraviolet rays from a UV lamp, 3) no titanium oxide was added, and the system was agitated while being irradiated with ultraviolet rays (0.4 mW/cm²) from a UV lamp, 4) no titanium oxide was added, and the system was agitated, but was not irradiated with ultraviolet rays from a UV lamp, and 5) no titanium oxide was added, and the system was neither agitated nor irradiated with ultraviolet rays from a UV lamp. The water was sampled 1, 2, 4, 8, and 24 hours after the start of the experiment, and the change in the COD concentration in the sewage was examined.

(2) Results

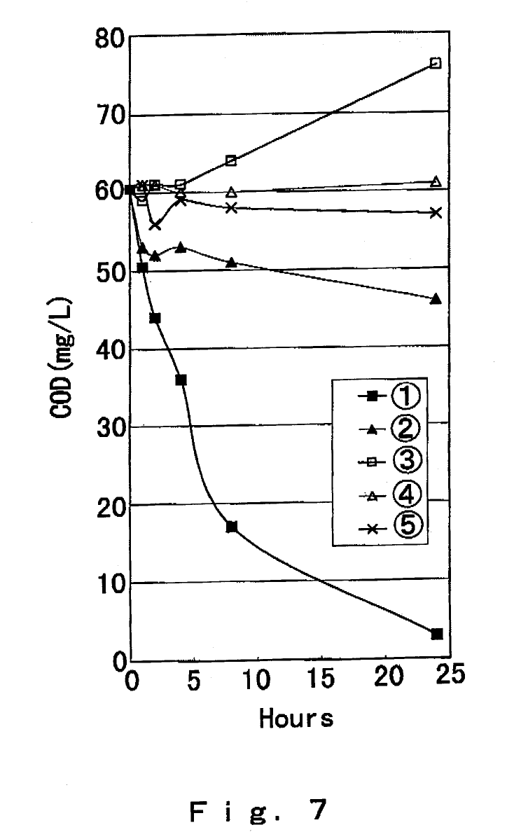

The results are given in FIG. 7. As is clear from this graph, the effect of water purification was particularly good, with the agricultural water quality standard COD of 6 mg/L being met or exceeded, in the case of 1) above, when 5.0 g of titanium oxide was added and the system was agitated while being irradiated with ultraviolet rays from a UV lamp. This confirmed that an excellent effect of water purification attributable to the photocatalytic action of titanium oxide can be obtained when titanium oxide is added in an amount of 5.0 g per 500 mL of sewage when the system is irradiated with ultraviolet rays at 0.4 mW/cm² while being agitated.

### Example 1

(1) Production of Catalyst Supporting Iron and Titanium Oxide

The effect of water purification attributable to the photocatalytic action of titanium oxide was confirmed in Reference Examples 1 to 4 above, but since the titanium oxide was in the form of fine particles 17 nm or smaller in size, once the titanium oxide became suspended in the water to be treated, it was difficult to separate it from the treated water after the treatment. In view of this, manganese-zinc ferrite, which is an iron oxide with a large particle size, was compounded to produce a catalyst supporting iron and titanium oxide, and the ease of separation of this catalyst was examined. The particle size of the catalyst supporting iron and titanium oxide was 0.3 μm, and the weight ratio of titanium oxide to iron oxide was 1:1.

(2) Method

The effect of water purification attributable to the photocatalytic action of the catalyst supporting iron and titanium oxide was examined at different amounts of catalyst supporting iron and titanium oxide and under agitation and irradiation with ultraviolet rays (0.4 mW/cm²), 6 g, 10 g, and 14 g of catalyst supporting iron and titanium oxide was put into hard glass 500 mL beakers containing sewage with a COD concentration of 53 mg/L. As comparative examples, the results were examined when no catalyst supporting iron and titanium oxide was added and the system was agitated (control 1), and when there was no ultraviolet irradiation, no catalyst supporting iron and titanium oxide was added, and there was no agitation (control 2). The water was sampled 2, 4, 8, and 24 hours after the start of the experiment, and the change in the COD concentration in the sewage was examined.

(3) Results

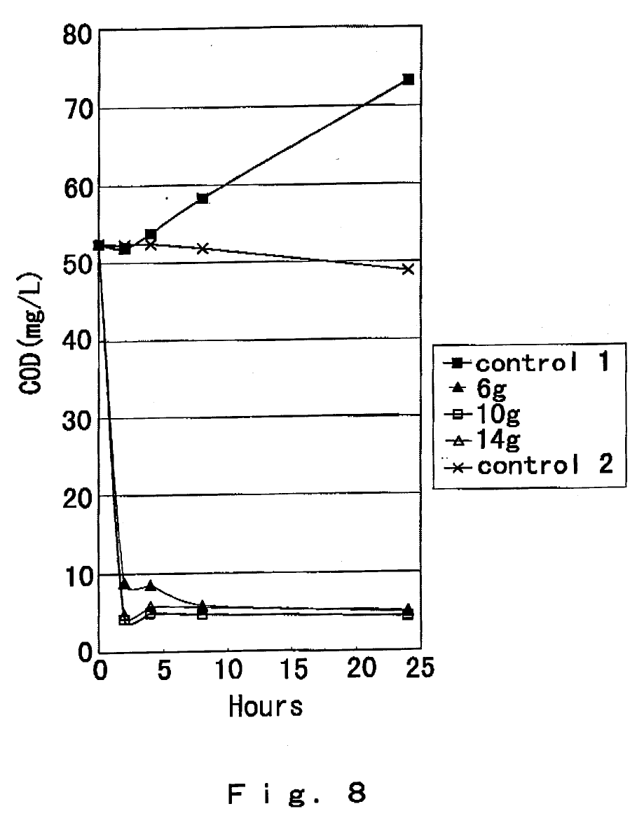

The results are given in FIG. 8. As is clear from this graph, when the catalyst supporting iron and titanium oxide was added, the COD concentration in the sewage dropped sharply within 2 hours, and the COD concentration leveled off at 5 to 6 mg/L thereafter. It was found that the most efficient amount in which to add the catalyst supporting iron and titanium oxide was 10 g (5 g of titanium oxide and 5 g of iron oxide) per 500 ma of sewage, and that the catalyst supporting iron and titanium oxide could be separated after treatment merely by a decantation operation in which the vessel was tilted and the supernatant taken off.

(4) Comparative Experiment

The effect of water purification attributable to the iron oxide monomer was examined at different amounts of iron oxide, 1 g, 3 g, and 5 g manganese-zinc ferrite (iron oxide) was put into hard glass 500 mL beakers containing sewage with a COD concentration of 66 mg/L, and the contents were agitated with a stirrer without being irradiated with ultraviolet rays. The water was sampled 1, 2, 4, 8, and 24 hours after the start of the experiment, and the COD concentration in the sewage was examined. As a comparative example, the results were examined when no iron oxide was added and the system was agitated (control 1), and when no iron oxide was added and there was no agitation (control 2).

(5) Results of Comparative Experiment

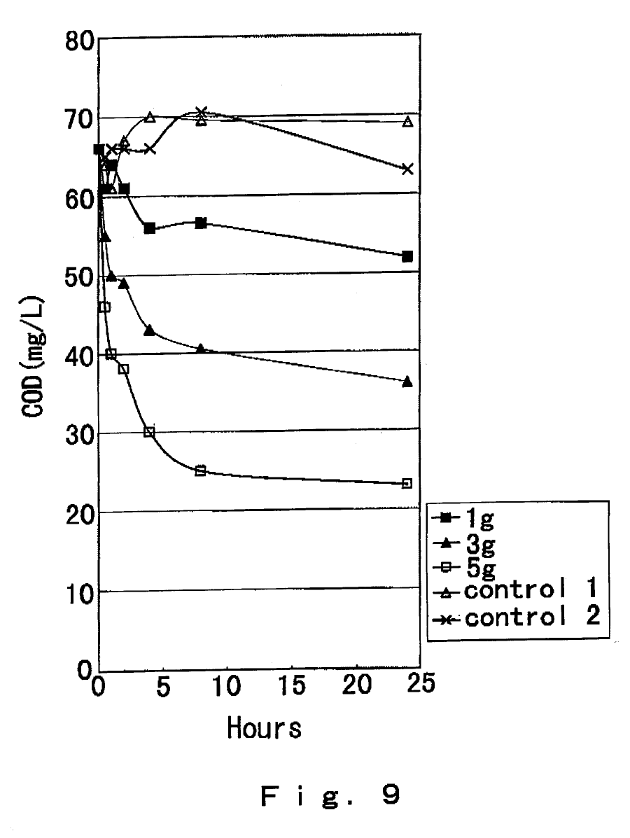

The results are given in FIG. 9. As is clear from this graph, the COD concentration in the sewage decreased as the amount of iron oxide added increased. At an added amount of 5 g, the effect of water purification was only about two-thirds that in the examples. It is clear that the effect of water purification here was inferior to that of a catalyst supporting iron and titanium oxide. The iron oxide precipitated upon completion of the experiment.

### Example 2

(1) Method

The effect of water purification attributable to the catalyst supporting iron and titanium oxide was examined in detail by measuring the change in COD concentration occurring within 2 hours, 10 g of catalyst supporting iron and titanium oxide (5 g of titanium oxide and 5 g of iron oxide) was put into a hard glass 500 mL beaker containing sewage with a COD concentration of 44 mg/L, and the samples were irradiated with ultraviolet rays (0.4 MW/cm²) from a UV lamp and agitated with a stirrer for 15, 30, 45, or 60 minutes. The water was sampled after waiting for precipitation for 15 minutes after the agitation was stopped, and the change in the COD concentration in the sewage was examined 15, 30, 45, 60, 75, and 120 minutes after the start of the experiment. As comparative examples, the results were examined when no catalyst supporting iron and titanium oxide was added and there was no agitation, but there was ultraviolet irradiation (control 1), and when a catalyst supporting iron and titanium oxide was added and the system was agitated, but there was no ultraviolet irradiation (control 2).

(2) Results

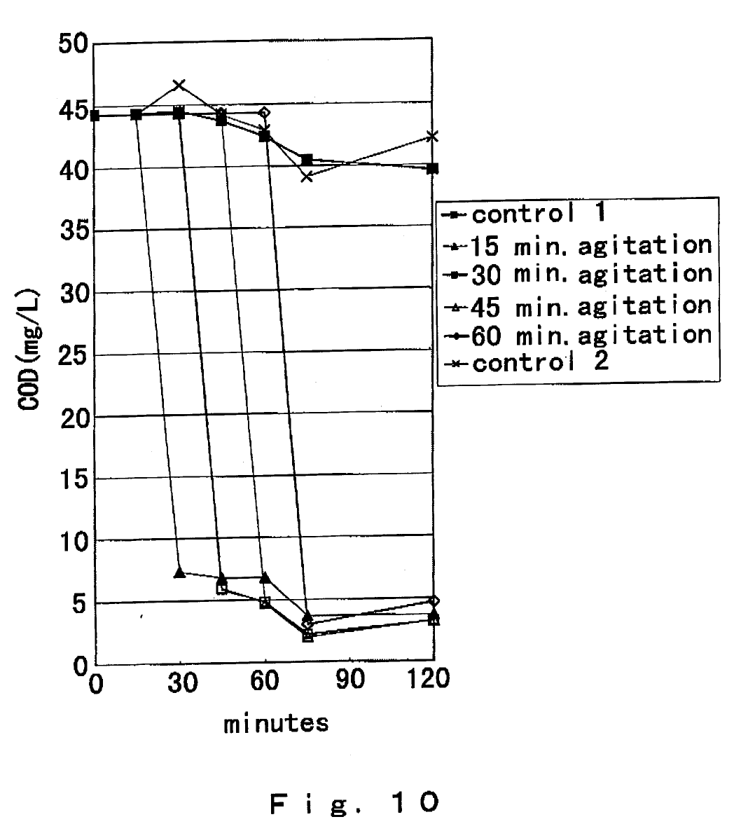

The results are given in FIG. 10. As is clear from this graph, the COD concentration following the addition of the catalyst supporting iron and titanium oxide, agitation, and precipitation satisfied the agricultural water quality standard COD of 6 mg/L or less. Based on the numerical values in Table 1, and taking measurement error and safety into account, it was found that the most efficient treatment method involves 45 minutes of agitation and 15 minutes of precipitation, for a total treatment time of 60 minutes.

TABLE 1

| | | COD at time after start | | | | | | |
|---|---|---|---|---|---|---|---|---|
| | | of experiment (mg/L) | | | | | | |
| | COD at | 15 | 30 | 45 | 60 | 75 | 120 | Time* |
| | start | min | min | min | min | min | min | (min) |
| 15 min. | 44.3 | | 7.3 | 6.8 | 6.8 | 3.7 | 3.7 | 75 |
| agitation | | | | | | | | |
| 30 min. | 44.3 | | | 5.9 | 4.8 | 2.2 | 3.2 | 45 |
| agitation | | | | | | | | |
| 45 min. | 44.3 | | | | 4.7 | 2.0 | 3.2 | 60 |
| agitation | | | | | | | | |
| 60 min. | 44.3 | | | | | 3.0 | 4.7 | 75 |
| agitation | | | | | | | | |
| control 1 | 44.3 | 44.3 | 44.5 | 43.7 | 42.4 | 40.5 | 39.6 | |
| Control 2 | 44.3 | 44.3 | 46.6 | 44.2 | 42.9 | 39.1 | 42.2 | |

[*Time until the COD dropped to the agricultural water quality standard COD of 6 mg/L or less]

### Example 3

(1) Method

The limit to the effect of water purification attributable to the catalyst supporting iron and titanium oxide was examined at different concentrations for the sewage water before treatment, 500 mL of sewage in three levels of COD concentration of 136 mg/L, 77 mg/L, and 43 mg/L was put into hard glass beakers, 10 g of catalyst supporting iron and titanium oxide (5 g of titanium oxide and 5 g of iron oxide) was added, and the system was irradiated with ultraviolet rays (0.4 mW/cm²) from a UV lamp and agitated with a stirrer for 45 minutes. After the agitation was stopped, the catalyst was allowed to precipitate for 15 minutes, after which the water was sampled 1, 2, 4, 8, and 24 hours after the start of the experiment, and the change in the COD concentration in the sewage was examined. As a comparative example, 500 mL of sewage in three levels of COD concentration was treated with neither agitation nor ultraviolet irradiation.

(2) Results

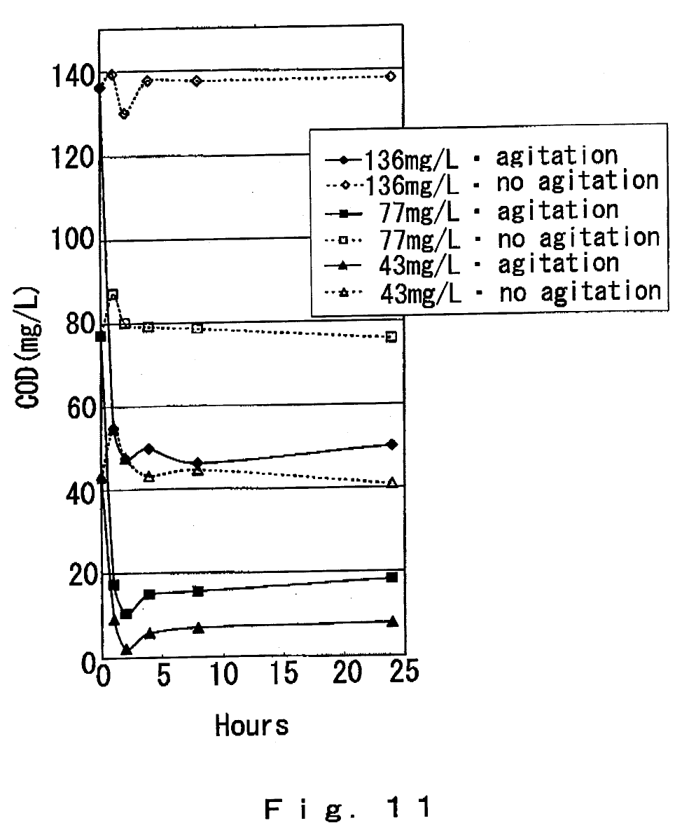

The results are given in FIG. 11. As is clear from this graph, the COD concentration after treatment was only under the agricultural water quality standard COD of 6 mg/L when the sewage concentration was 43 mg/L. To make an overall evaluation from FIGS. 8, 10, and 11, if we assume that the COD concentration must be 6 mg/L or less after treatment, then the upper limit to the water purification capability of the catalyst supporting iron and titanium oxide is a COD concentration of about 50 mg/L in the sewage water. Still, it was found that a concentration over 50 mg/L can be handled by adding the catalyst supporting iron and titanium oxide to the treated water again, and performing the treatment in stages.

### Example 4

(1) Method

The effect of water purification attributable to the catalyst supporting iron and titanium oxide was examined with and without the use of light, 500 mL of sewage with a COD concentration of 56 mg/L was put into five hard glass beakers, and five samples were prepared: 1) 10.0 g of catalyst supporting iron and titanium oxide was added and the system was agitated while being irradiated for 120 minutes with ultraviolet rays (0.4 mW/cm²) from a UV lamp, 2) 10.0 g of titanium oxide was added and the system was agitated, but was not irradiated with a UV lamp (including one that had already been irradiated with light), 3) 5.0 g of titanium oxide was added, and the system was agitated while being irradiated for 120 minutes with ultraviolet rays (0.4 mW/cm²) from a UV lamp, 4) no titanium oxide or catalyst supporting iron and titanium oxide was added, and the system was agitated while being irradiated for 120 minutes with ultraviolet rays (0.4 mW/cm²) from a UV lamp, and 5) no titanium oxide or catalyst supporting iron and titanium oxide was added, and the system was neither agitated nor irradiated with ultraviolet rays from a UV lamp. The water was sampled 30, 60, and 120 minutes after the start of the experiment, and the change in the COD concentration in the sewage was examined,

(2) Results

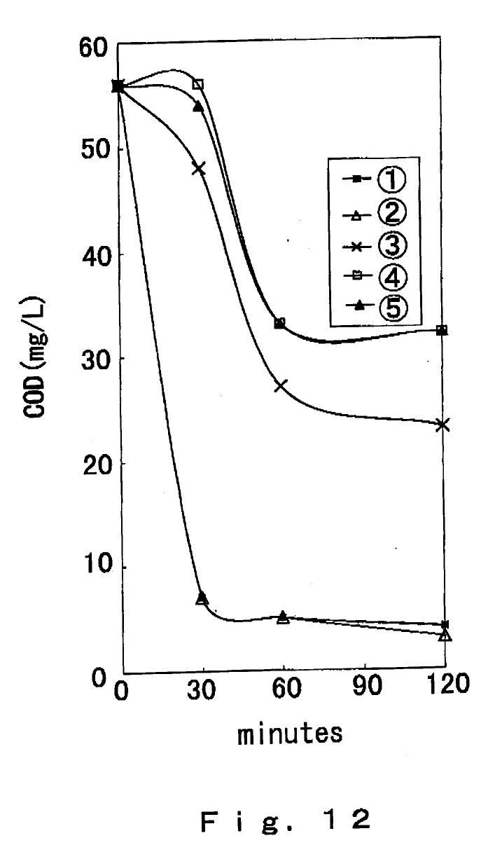

The results are given in FIG. 12. As is clear from this graph, speedy water purification could be achieved, and the COD was under the agricultural water quality standard of 6 mg/L, only in 1) and 2) above. This confirmed that regardless of whether ultraviolet irradiation is performed, when there is a effect of water purification when 10.0 g of catalyst supporting iron and titanium oxide is added per 500 mL of sewage. This experiment demonstrates that in 2) above, when the catalyst supporting iron and titanium oxide is added and agitated, but there is no optical irradiation, the effect of water purification is substantially the same as that in 1) above.

As discussed in detail above, the present invention relates to a high-speed method for water purification and system thereof, characterized in that a catalyst supporting iron and titanium oxide is used to water to be treated containing suspended matter. The present invention 1) provides a method for water purification with which water can be treated easily, in a short time, and quickly, 2) allows the organic suspended matter, agrochemicals, endocrine disruptors, and so forth in sewage to be adsorbed, decomposed, and removed at high-speed and in a short time of 1 hour or less by a simple method in which a catalyst supporting iron and titanium oxide is added to the sewage and agitated for 45 minutes while being irradiated with ultraviolet rays, and then precipitated for 15 minutes, for example, 3) allows the adsorption, decomposition, sterile filtration, and precipitation of organic matter by a catalyst supporting iron and titanium oxide to be performed quickly merely by putting the catalyst supporting iron and titanium oxide into sewage, agitating or exposing the system to air while irradiating it with ultraviolet rays, and thereby introducing oxygen into the sewage, thereby making high-speed water purification possible, 5) allows the catalyst supporting iron and titanium oxide to be recovered for regeneration and reuse through the action of a magnet, and 6) provides a novel system for water purification used in the above method for water purification.

What is claimed is:

1. A method for water purification, comprising treating water containing suspended matter to obtain purified water by using a catalyst supporting iron and titanium oxide.

2. The method for water purification according to claim 1, wherein the catalyst supporting iron and titanium oxide is mixed into the water to be treated containing suspended matter, and thereby the suspended matter is adsorbed, decomposed, and then precipitated.

3. The method for water purification according to claim 2, wherein the catalyst supporting iron and titanium oxide is mixed into the water to be treated containing suspended matter while oxygen is introduced into the water.

4. The method for water purification according to claim 1, wherein a catalyst supporting iron and titanium oxide and supported on a carrier is brought into contact with the water to be treated containing suspended matter, and thereby the suspended matter is adsorbed, decomposed, and then precipitated.

5. The method for water purification according to claim 4, wherein a catalyst supporting iron and titanium oxide and supported on a carrier is brought into contact with the water to be treated containing suspended matter while oxygen is introduced into the water.

6. The method for water purification according to any of claims 1 to 5, wherein when the water to be treated contains a high concentration of suspended matter, the obtained treated water is purified by being put back into the water.

7. The method for water purification according to claim 2 or 3, wherein when the water to be treated contains a high concentration of suspended matter, the catalyst supporting iron and titanium oxide is put back into the water for purification of the water.

8. The method for water purification according to any of claims 1 to 7, wherein the used catalyst supporting iron and titanium oxide is separated and recovered from the treated water by utilizing the action of a magnet to be reused as needed.

9. The method for water purification according to claim 8, wherein in order to separate the catalyst supporting iron and titanium oxide from the treated water, an electromagnet is used to lift the catalyst supporting iron and titanium oxide out of the treatment tank to be reused.

10. The method for water purification according to claim 8, wherein in order to separate the catalyst supporting iron and titanium oxide from the treated water, an electromagnet is used to fix the catalyst supporting iron and titanium oxide on the bottom of the treatment tank to be reused after the treated water is drained.

11. The method for water purification according to any of claims 1 to 10, wherein the water to be treated is tap water, sewage, municipal runoff, agricultural runoff, industrial wastewater, lake or marsh water, or river water.

12. A method for water purification comprising the method for water purification according to any of claims 1 to 11 and another water purification process involving physical treatment, chemical treatment, or biological treatment combined with the method.

13. A water purifying agent to be used in the method for water purification according to any of claims 1 to 12, characterized by containing as an active component a catalyst supporting iron and titanium oxide that is manufactured by compounding an iron component with a titanium oxide-based photocatalyst.

14. The water purifying agent according to claim 13, wherein the iron component is one or more types selected from among metallic iron, iron oxide, and ferrates.

15. A system for water purification, comprising:
an agitation tank equipped with agitation means;
water to be treated introduction means;
treated water discharge means; and
optionally optical irradiation means,
wherein water to be treated containing suspended matter is introduced into the agitation tank, a catalyst supporting iron and titanium oxide is mixed into the water to purifying the water, and then the treated water is discharged from the treated water discharge means.

16. A compound system for water purification comprising system for water purification according to claim 15 as a constituent element and other water purification equipment involving physical treatment, chemical treatment, or biological treatment, combined with the system.
